(19) United States
(12) Patent Application Publication
(10) Pub. No.: US 2023/0325952 A1
(43) Pub. Date: Oct. 12, 2023

(54) Student Portal for maintaining, updating and retrieving tuition reimbursement offers

(71) Applicant: Aaron Richards, Venice, CA (US)

(72) Inventor: Aaron Richards, Venice, CA (US)

(21) Appl. No.: 17/718,325

(22) Filed: Apr. 12, 2022

(51) Int. Cl. G06Q 50/20; G06F 3/0488

(52) U.S. Cl. CPC G06Q 50/2053; G06F 3/0488

(57) ABSTRACT

A novel type of platform allowing students to analyze and manage their courses according to reimbursements funds available. The system with minimal user's input provides various features which allows ease of management and convenience for student. The invention is a software app accessible through mobile and computing devices and provides multiple inbuilt and paid features.

### DESCRIPTION OF THE RELATED ART

Many employers provide employee benefits, in the form of various benefits, plans and programs (hereinafter referred to as “benefits”), to their employees as part of their total compensation packages. These benefits may include employer provided personnel benefits, health insurance benefits, disability insurance benefits, life insurance benefits, pension benefits, retirement benefits, stock option programs, profit sharing programs, employee savings accounts and plans, employee credit union accounts and services, employee discount programs, and other valuable benefits and programs. The list can go on to include other employer-specific or industry-specific benefits.

Since the start of the pandemic, some workers have had to put their higher education goals on hold. Now, more companies are trying to help revive those college aspirations. Target and Walmart recently announced tuition reimbursement programs to help employees with the cost of going back to school. Amazon will reimburse up to 95% of tuition and fees for eligible employees.

Home Depot, NS, FedEx, Chipotle and Starbucks also have programs that help employees pay for college. Waste Management said it will not only pay for college degrees and professional certificates for employees going forward but will offer this same benefit to their spouses and children.

In today's job market, tuition assistance is one of the many incentive's companies are using to attract and keep workers. It may also be the most valuable.

Not only does free or discounted higher education improve recruitment and retention, it cuts down on student debt while advancing the long-term wellbeing of employees, experts say. Research shows there are substantial differences in lifetime earnings by educational attainment.

Also, there is another scenario of students who work for educational reimbursements. They also need an organized system to support and manage their tuition reimbursement. Oftentimes, the benefits which are provided are so complex in understanding and management, that the student may not be aware of them or know how to take advantage of them. In other instances, the reimbursements are available but student doesn't get time to manage his/her workloads and other educational stuff. In these instances, the employee will have to expend efforts and time, sometimes amounting to great efforts and a great deal of time, in order to obtain or mange his courses related stuff. Frustration may result when some important deadlines are missed or when there is time management issue arises.

There are multiple systems and architectures that have been proposed, in prior art regarding development of platforms for assistance of students However, the majority of programs are created for regular students. The current invention proposes a platform for part time students or professionals who are completing or continuing their education while they are employed or they are getting tuition reimbursements from their employers.

None of the previous inventions and patents, taken either singly or in combination, is seen to describe the instant invention as claimed. Hence, the inventor of the present invention proposes to resolve and surmount: existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims and abstract as a whole.

The objective of the invention is to provide an online and offline educational system for students who work for employers offering tuition reimbursement.

It is also the objective of the system to provide an educational hands-on app for users allowing to analyze reimbursement funds available

According to another aspect of the invention, it is also the objective of the invention to provide suggested course load based on expected contribution to the users.

It is also a feature of the invention to provide contribution calculator.

According to another aspect of the invention, it also aims to send various types of alerts including but not limited to low funds, low grades and so on.

According to another aspect of the invention, it is aimed to provide links and alerts for parents' access.

It is further ne objective of system to provide 24/7 Chat/email support for the users.

According to another aspect of the invention the system compatible with both Android and iOS Systems.

It is further the objective of system to provide counselling session for students on request with additional payments.

Other aspects, advantages and novel features of the present invention will become apparent from the detailed description of the invention when considered in conjunction with the accompanying claims.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to provide a hands-on app to students to manage their tuition reimbursements and related courses management.

Another aspect of the student portal disclosed herein is a software module which is associated with online management of student's reimbursements and course work.

The invention, which is a student portal can be viewed and used from a personal computer, laptop, PDA or any computing device. In order to use the web-based application, the user has to be connected to internet to use multiple features. For real time utility needs to be connected to internet through local area networks (“LANs”)/wide area networks (“WANs”), wireless network or independent internet source. Further, the internet would connect the user to the online feedback application server, through the user's computing or mobile device, where applicable.

Generally, client device may include virtually any computing device capable of receiving and sending a message over a network, such as LAN/WAN or independent network, wireless network, and the like, to and from another computing device, such as server or mobile device, and the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, Tablets or PDAs. Similarly, client device may be any device that is capable of connecting using a wired or wireless communication medium such as a PDA, POCKET PC, wearable computer, and any other device that is equipped to communicate over a wired and/or wireless communication medium.

Student device may include a browser application that is configured to receive and to send web pages, web-based messages, and the like. The browser application may be configured to receive and display graphics, text, multimedia, and the like, employing virtually any web-based language, including Standard Generalized Markup Language (SMGL), HyperText Markup Language (HTML), and so forth.

Student device may also include mobile computing devices especially the smartphone, which allow the user to download the application and use it on one click. The online website has a responsiveness mode for the application to function in full on the mobile computing device. Any mobile computing device can be used by the user for using the application. Such devices include portable devices such as, cellular telephones, smart phones, Personal Digital Assistants (PDAs), handheld computers, wearable computers, tablet computers, integrated devices combining one or more of the preceding devices, and the like.

The system is designed to have two ends. One is the front end which is designed as the front panel with GUI for taking the user's input and the second one is the back end that is the server end. All information entered is stored in the database server according to given format. The same database gives and shares multiple features including but not limited to expected graduation date, funds availability, suggested course load, contribution calculator, alerts and notifications and chat/email support. The user registration is also stored and verified by the same server. The server is also been used to host the site and application.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An educational hands-on app comprising:
a display for displaying content to a user;
a touch sensitive surface for allowing user input; and
a user interface including a student mode configured to provide selective access to features available.

2. As per claim 1, the system displays reimbursement funds available;

3. As per claim 1; the system displays expected graduation date of student;

4. As per claim 1, the system displays suggested course load based on expected contribution;

5. As per claim 1, the system displays the contribution calculator;

6. As per claim 1, the system sends alerts/notifications;

7. As per claim 1, the system provides parental access;

8. As per claim 1, the system provides 24/7 Chat/email support; and,

9. As per claim 1, the system can also provide exclusive counselling session on additional payment.
